(19) United States
(12) Patent Application Publication
(10) Pub. No.: US 2026/0072546 A1
(43) Pub. Date: Mar. 12, 2026

(54) INPUT DEVICE

(71) Applicant: ALPS ALPINE CO., LTD., Tokyo (JP)

(72) Inventors: Tomoki YAMADA, Miyagi (JP); Yoshiya NAKATA, Miyagi (JP); Takuma MOTOI, Tokyo (JP)

(21) Appl. No.: 19/388,288

(22) Filed: Nov. 13, 2025

Related U.S. Application Data
(63) Continuation of application No. PCT/JP2024/007935, filed on Mar. 4, 2024.

(30) Foreign Application Priority Data
Jun. 1, 2023 (JP) 2023-090679

(51) Int. Cl. G06F 3/041; G06F 3/02; G06F 3/044

(52) U.S. Cl. CPC G06F 3/0418; G06F 3/02; G06F 3/0447

(57) ABSTRACT

An input device includes an input section having an operating surface to be operated by a manipulating body, detection electrodes provided on a back side of the operating surface, a measurement unit that measures an electrostatic capacitance value of each of the detection electrodes, and a correction unit that corrects the electrostatic capacitance value of each of the detection electrodes measured by the measurement unit. The input section includes portions where displacements with respect to a pressing operation on the operating surface by the manipulating body with a predetermined pressing force differ depending on positions on the operating surface. The correction unit corrects the electrostatic capacitance value of each of the detection electrodes using smaller correction values for cases where a displacement caused by the pressing operation performed at pressing positions overlapping the detection electrodes on the operating surface in a plan view becomes larger.

### CROSS-REFERENCE TO RELATED APPLICATIONS

This application is a continuation application of International Application No. PCT/JP2024/007935 filed on Mar. 4, 2024 and designated the U.S., which is based upon and claims priority to Japanese Patent Application No. 2023-090679, filed on Jun. 1, 2023, the entire contents of which are incorporated herein by reference.

### BACKGROUND OF THE INVENTION

### 1. Field of the Invention

The present disclosure relates to input devices.

### 2. Description of the Related Art

A tactile force sensing device of the related art has a capacitive load sensor and a capacitive sensing unit. The capacitive load sensor includes a first electrode plate on which a plurality of positive electrodes are arranged in an array on a single plane, a second electrode plate on which a single negative electrode is arranged, and a cylinder disposed between the first electrode plate and the second electrode plate to form a plurality of capacitors. The capacitive sensing unit detects a capacitance of each capacitor of the plurality of capacitors that varies according to an external force applied to the second electrode plate of the capacitive load sensor. The tactile force sensing device further has a distributed load measurement unit that measures a distributed load representing a distribution of a load applied to the cylinder based on a variation in the capacitance of each capacitor detected by the capacitive sensing unit, and a load information calculation unit that calculates a total load and a load center position of an external force applied to the second electrode plate based on a relationship between a cylinder stroke length with respect to the distributed load and a pattern of the distributed load (refer to Japanese Laid-Open Patent Publication No. 2020-187069, for example).

However, because the tactile force sensing device of the related art does not assume a case where a hardness of a sensor operating surface is non-uniform, it is not possible to determine presence of a pressing operation with respect to the sensor operating surface based on fixed criteria in the case where the hardness of the sensor operating surface is non-uniform.

### SUMMARY OF THE INVENTION

Accordingly, it is an object of the present disclosure to provide an input device capable of determining presence of a pressing operation with respect to a sensor operating surface based on fixed criteria.

An input device according to an embodiment of the present disclosure includes an input section having an operating surface configured to be operated by a manipulating body; a plurality of detection electrodes provided on a back side of the operating surface; a measurement circuit configured to measure an electrostatic capacitance value of each detection electrode of the plurality of detection electrodes; and a correction circuit configured to correct the electrostatic capacitance value of each detection electrode of the plurality of detection electrodes measured by the measurement circuit, wherein the input section is configured to include portions where displacements with respect to a pressing operation on the operating surface by the manipulating body with a predetermined pressing force differ depending on positions on the operating surface, and the correction circuit is configured to correct the electrostatic capacitance value of each detection electrode of the plurality of detection electrodes using smaller correction values for cases where a displacement caused by the pressing operation performed at pressing positions overlapping the plurality of detection electrodes on the operating surface in a plan view becomes larger.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a diagram illustrating an example of a configuration of an input device according to an embodiment.

FIG. 2A is a diagram illustrating an example of a state where a fingertip performs a pressing operation on the input device according to the embodiment;

FIG. 2B is a diagram illustrating an example of another state where the fingertip performs the pressing operation on the input device according to the embodiment;

FIG. 3 is a diagram illustrating an example of an output of an electrostatic sensor of the input device according to the embodiment;

FIG. 4 is a diagram illustrating another example of the output of the electrostatic sensor of the input device according to the embodiment;

FIG. 5 is a diagram illustrating an example of a cross sectional configuration of the input device according to a modification of the embodiment;

FIG. 6A is a diagram illustrating an example of a state where the fingertip performs the pressing operation on the input device according to the modification of the embodiment; and

FIG. 6B is a diagram illustrating another example of the state where the fingertip performs the pressing operation on the input device according to the modification of the embodiment.

### DESCRIPTION OF THE PREFERRED EMBODIMENTS

Hereinafter, embodiments applied with an input device according to the present disclosure will be described.

An XYZ coordinate system will be defined and described in the following. A direction (X-direction) parallel to an X-axis, a direction (Y-direction) parallel to a Y-axis, and a direction (Z-direction) parallel to a Z-axis are perpendicular to one another. In the following, as an example, a vertical direction used in the description regards a +Z-direction side as an upward side and a −Z-direction side as a downward side, but the vertical direction does not represent a universal vertical direction. Further, a plan view refers to a view normal to an XY-plane. In the following description, a length, a width, a thickness, or the like of each component may be exaggerated to facilitate understanding of the configuration.

### Embodiment

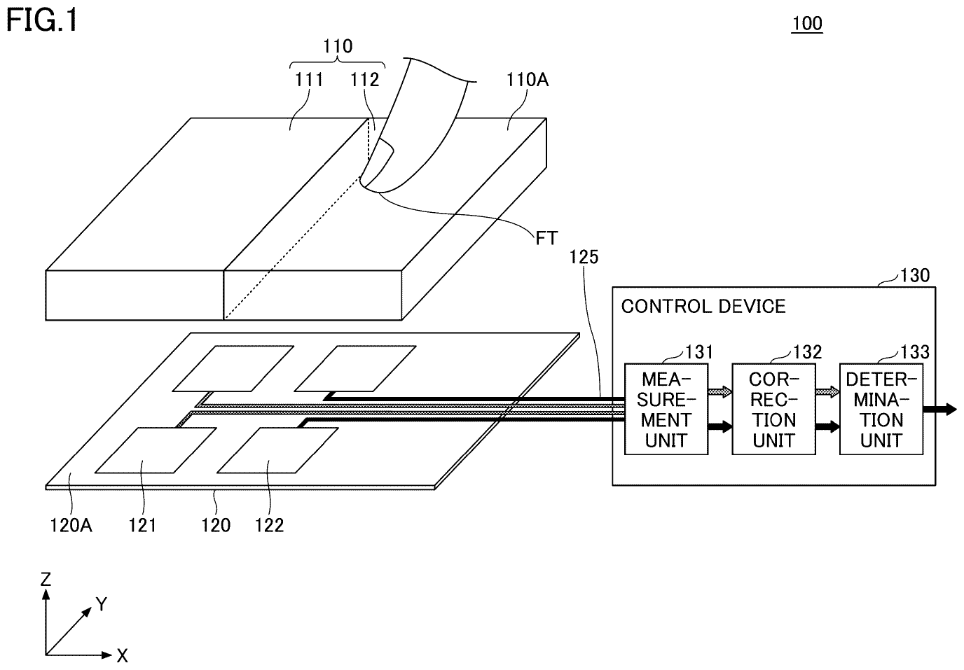

FIG. 1 is a diagram illustrating an example of a configuration of an input device 100 according to an embodiment. The input device 100 includes a foam layer 110, an electrostatic sensor 120, and a control device 130. The foam layer 110 is an example of an input section, and an upper surface of the foam layer 110 constitutes an operating surface 110A.

When a user performs a pressing operation by pressing the operating surface 110A in a downward direction with a fingertip FT, and the input device 100 determines that the pressing operation is performed based on an electrostatic capacitance value between the fingertip FT and the electrostatic sensor 120, the input device 100 confirms an operational content of the pressing operation. The input device 100 can be operated by a hand or the like other than the fingertip FT, but a case where the operation is performed by the fingertip FT will be described below. The fingertip FT, the hand, or the like of the user are examples of a manipulating body.

The input device 100 can be attached to a part having cushioning properties, such as a door panel, an armrest, or the like of a vehicle, for example, but the input device 100 may be attached to other parts of the vehicle. The input device 100 may be installed on platforms other than the vehicle, such as a train, an aircraft, or the like. The platform on which the input device 100 is installed is not limited to a mobile platform, such as the vehicle, the train, the aircraft, or the like, and the input device 100 may be attached to an interior of a building or the like. Hereinafter, a case where the input device 100 is installed on the vehicle will be described as an example.

### <Foam Layer 110>

The foam layer 110 is disposed on the electrostatic sensor 120. In FIG. 1, the foam layer 110 and the electrostatic sensor 120 are illustrated separately in order to facilitate understanding of the configuration of the electrostatic sensor 120, but in actual practice, the foam layer 110 is disposed in a state superimposed on the electrostatic sensor 120.

The foam layer 110 can be made of a foam material, such as urethane foam, sponge foam, rubber foam, or the like, and has cushioning properties. The upper surface of the foam layer 110 may be covered with a skin (not illustrated). In this case, an upper surface of the skin serves as the operating surface of the input device 100.

The foam layer 110 includes a foam layer 111 and a foam layer 112. The foam layer 111 and the foam layer 112 have identical thicknesses in the Z-direction, and heights of upper surfaces of the foam layer 111 and the foam layer 112 are aligned. The foam layer 111 is harder than the foam layer 112, and the foam layer 112 is softer than the foam layer 111. The foam layer 111 and the foam layer 112 may be manufactured separately or manufactured integrally.

### <Electrostatic Sensor 120>

The electrostatic sensor 120 is provided under the foam layer 110. The electrostatic sensor 120 includes a substrate 120A and a plurality of detection electrodes 121 and 122, for example. More specifically, the electrostatic sensor 120 includes two detection electrodes 121 and two detection electrodes 122, for example. The detection electrodes 121 and 122 are provided on a surface of the substrate 120A on the +Z-direction side, for example. The substrate 120A is a printed circuit board. The two detection electrodes 121 are located under the foam layer 111, and the two detection electrodes 122 are located under the foam layer 112.

Areas of the detection electrodes 121 and 122 are identical in the plan view, for example, and outer diameters and shapes of the detection electrodes 121 and 122 are identical. The detection electrodes 121 and 122 are connected to the control device 130 via an interconnect 125. The electrostatic sensor 120 may include at least one detection electrode 121 and at least one detection electrode 122. The electrostatic sensor 120 may include three or more detection electrodes located at different positions along the X-direction.

### <Control Device 130>

The control device 130 includes a measurement unit 131, a correction unit 132, and a determination unit 133. Although FIG. 1 illustrates a configuration in which the measurement unit 131, the correction unit 132, and the determination unit 133 are disposed inside one control device 130 as an example, the measurement unit 131, the correction unit 132, and the determination unit 133 may be configured by separate integrated circuits (ICs), micro controller units (MCUs), or the like, for example. That is, the measurement unit 131, the correction unit 132, and the determination unit 133 may be configured by a measurement circuit, a correction circuit, and a determination circuit, respectively. The measurement unit 131, the correction unit 132, and the determination unit 133 may be functional blocks implemented by the MCU executing one or more computer programs stored in a memory, for example.

The measurement unit 131 measures electrostatic capacitance values of the detection electrodes 121 and 122, respectively, and outputs the electrostatic capacitance values to the determination unit 133.

The correction unit 132 corrects the electrostatic capacitance values of the detection electrodes 121 and 122 measured by the measurement unit 131. A method of correcting the electrostatic capacitance values of the detection electrodes 121 and 122 by the correction unit 132 will be described later.

The determination unit 133 determines that the manipulating body performed a pressing operation on the operating surface 110A in a case where the electrostatic capacitance value corrected by the correction unit 132 is greater than or equal to a predetermined threshold value.

### <Pressing Operation>

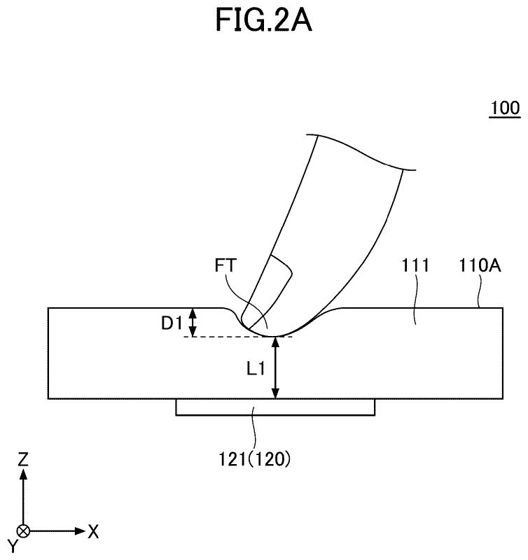

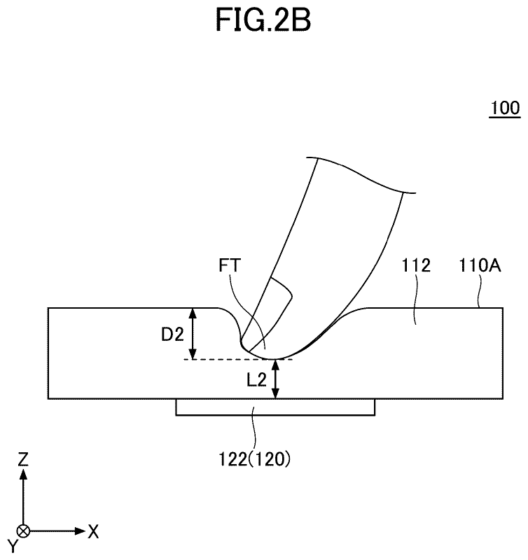

FIG. 2A and FIG. 2B are diagrams illustrating examples of states where the fingertip FT performs the pressing operation on the input device 100.

Hereinafter, a case where the pressing operation is performed on the foam layers 111 and 112 with a predetermined pressing force will be described. Predetermined pressing forces on the foam layers 111 and 112 when performing the pressing operation are identical. The predetermined pressing force is a force that lightly presses the operating surface 110A downward, for example.

FIG. 2A illustrates only the foam layer 111 of the input device 100. The detection electrodes 121 are provided under the foam layer 111. In addition, FIG. 2B only illustrates the foam layer 112 of the input device 100. The detection electrodes 122 are provided under the foam layer 112. In FIG. 2A and FIG. 2B, the illustration of the interconnect 125 and the control device 130 is omitted.

Because the foam layer 111 is hard, it is difficult to press the foam layer 111 downward when a pressing operation is performed with the predetermined pressing force as illustrated in FIG. 2A. In this case, a displacement of the upper surface (operating surface 110A) of the foam layer 111 in the Z-direction is indicated by D1.

The foam layer 112 is softer than the foam layer 111 (refer to FIG. 2A), and thus, the foam layer 112 is easily deformable into a concave shape. For this reason, as illustrated in FIG. 2B, when a pressing operation is performed on the upper surface (operating surface 110A) of the foam layer 112 with the predetermined pressing force, the foam layer 112 is easily pressed downward. In this case, a displacement of the upper surface (operating surface 110A) of the foam layer 112 in the Z-direction is indicated by D2. The displacement D2 is larger than the displacement D1.

Because the foam layer 112 is softer and more easily deformable than the foam layer 111, the displacement D2 by the same predetermined pressing force as in the case of FIG. 2A is larger than the displacement D1 in FIG. 2A. For this reason, a distance L2 in the Z-direction between the fingertip FT and the detection electrode 122 when the pressing operation is performed on the foam layer 112 with the predetermined pressing force is shorter than a distance L1 in the Z-direction between the fingertip FT and the detection electrode 121 when the pressing operation is performed on the foam layer 111 with the predetermined pressing force.

Because an output of the electrostatic sensor 120 represents the electrostatic capacitance value between the fingertip FT and the detection electrode located directly under the fingertip FT, when the pressing operation is performed with the same force, the output becomes different between the case where the pressing operation is performed on the hard foam layer 111 illustrated in FIG. 2A and the case where the pressing operation is performed on the soft foam layer 112 illustrated in FIG. 2B. This is because the displacements D1 and D2 are different.

More specifically, the output of the electrostatic sensor 120 (electrostatic capacitance value of the detection electrode 122) when the pressing operation is performed on the soft foam layer 112 as illustrated in FIG. 2B is larger than the output of the electrostatic sensor 120 (electrostatic capacitance value of the detection electrode 121) when the pressing operation is performed on the hard foam layer 111 as illustrated in FIG. 2A. This is because the distance between the fingertip FT and the detection electrode for the case illustrated in FIG. 2B is L2 and shorter than the distance L1 for the case illustrated in FIG. 2A.

Accordingly, the foam layer 110 includes the foam layers 111 and 112 having different hardnesses, and thus, the foam layer 110 includes portions where the displacements with respect to the pressing operation on the operating surface 110A by the fingertip FT with the predetermined pressing force differ depending on the positions on the operating surface 110A.

### <Output of Electrostatic Sensor 120>

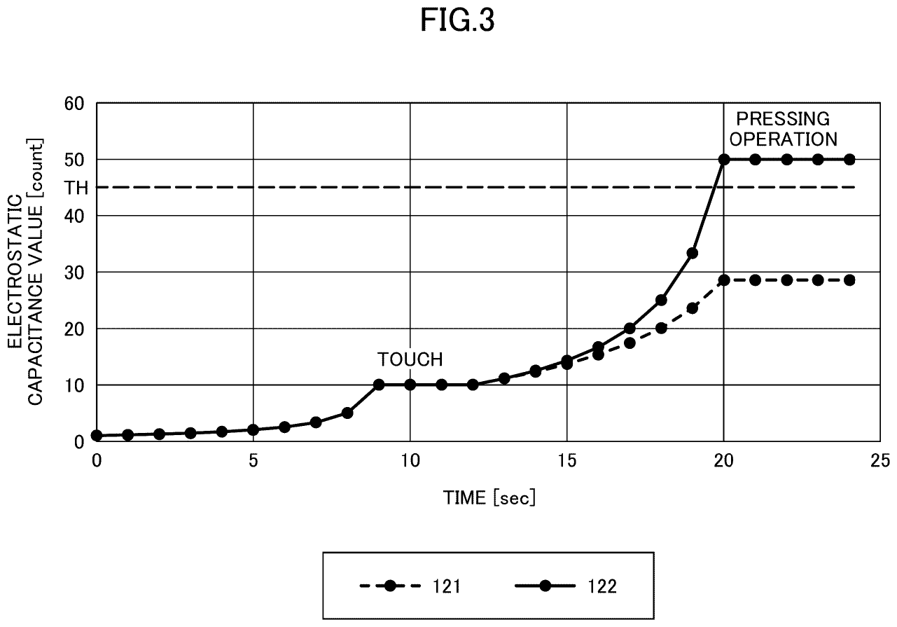

FIG. 3 is a diagram illustrating an example of the output of the electrostatic sensor 120. FIG. 3 illustrates the electrostatic capacitance value (broken line) of the detection electrode 121 of the electrostatic sensor 120 when the pressing operation is performed on the hard foam layer 111 with the predetermined pressing force as illustrated in FIG. 2A, and the electrostatic capacitance value (solid line) of the detection electrode 122 of the electrostatic sensor 120 when the pressing operation is performed on the soft foam layer 112 with the predetermined pressing force as illustrated in FIG. 2B.

The abscissa in FIG. 3 represents the time (seconds). The pressing operation on the hard foam layer 111 and the pressing operation on the soft foam layer 112 are performed in the same manner with respect to a lapse of time. More specifically, the fingertip FT is sufficiently away from the operating surface 110A at a time of 0 second, approaches the operating surface 110A with the lapse of time, touches the operating surface 110A at a time of 10 seconds, and performs the pressing operation on or after 10 seconds.

The ordinate in FIG. 3 represents the output of the electrostatic sensor 120 (electrostatic capacitance values of the detection electrodes 121 and 122). The electrostatic capacitance values of the detection electrodes 121 and 122 are represented by electrostatic capacitance count values. The electrostatic capacitance count values are difference values obtained by digitally converting the electrostatic capacitance values (analog values) of the detection electrodes 121 and 122 and subtracting a predetermined reference value, respectively. The predetermined reference value corresponds to an electrostatic capacitance count value of the electrostatic capacitance values of the detection electrodes 121 and 122 in a state where the operation by the fingertip FT is not performed on the electrostatic sensor 120, and represents a noise floor. In addition, a threshold value TH is a value based on which the control device 130 determines that a pressing operation is performed, and is assumed to be 45 in terms of the electrostatic capacitance value in the following description.

As indicated by the solid line, when the pressing operation is performed on the soft foam layer 112 with the predetermined pressing force, the electrostatic capacitance value of the detection electrode 122 becomes greater than or equal to the threshold value TH at a time of 20 seconds, and becomes a constant value of 50 on or after the time of 20 seconds. On or after the time of 20 seconds, the predetermined pressing force and a reaction force of the foam layer 112 become balanced, and the foam layer 112 assumes a state where the foam layer 112 cannot be pressed further downward.

As indicated by the broken line, when the pressing operation is performed on the hard foam layer 111 with the predetermined pressing force, the electrostatic capacitance value of the detection electrode 121 becomes less than the threshold value TH at the time of 20 seconds, and becomes a constant value of approximately 28 on or after the time of 20 seconds. On or after the time of 20 seconds, the predetermined pressing force and a reaction force of the foam layer 111 become balanced, and the foam layer 111 assumes a state where the foam layer 111 cannot be pressed further downward. When the pressing operation is performed with the predetermined pressing force, the electrostatic capacitance value of the detection electrode 121 is smaller than the electrostatic capacitance value of the detection electrode 122.

Accordingly, when the pressing operation is performed on the foam layers 111 and 112 with the predetermined pressing force, because the hardnesses of the foam layers 111 and 112 differ, it is determined that the pressing operation is performed when the pressing operation is performed on the foam layer 112, but it is determined that no pressing operation is performed when the pressing operation is performed on the foam layer 111. In order to complete the pressing operation on the foam layer 111, it is necessary to perform the pressing operation with a force larger than the predetermined pressing force.

It is also conceivable to determine that the pressing operation is performed with the predetermined pressing force on both the hard foam layer 111 and the soft foam layer 112 by lowering the threshold value TH to approximately 20, for example. However, if the threshold value TH is lowered to approximately 20, for example, it is determined that the pressing operation is performed even in a case where the pressing operation is performed on the soft foam layer 112 with a pressing force smaller than the predetermined pressing force, and a difference in tactile sensation occurs. For this reason, the problem described above is solved in the following manner without changing the threshold value TH.

The input device 100 solves the problem described above by performing a correction by the correction unit 132 so that the electrostatic capacitance values of the detection electrodes 121 and 122 become identical when the pressing operation is performed with the predetermined pressing force.

As an example, the correction unit 132 corrects the electrostatic capacitance values of the detection electrodes 121 and 122, so that the electrostatic capacitance value of the detection electrode 121 when the pressing operation is performed with the predetermined pressing force becomes identical to the electrostatic capacitance value of the detection electrode 122 when the pressing operation is performed with the predetermined pressing force. A correction value multiplied to the electrostatic capacitance value of the detection electrode 121 when the correction unit 132 corrects the electrostatic capacitance value of the detection electrode 121 is a ratio (50/28) that is obtained by dividing the electrostatic capacitance value (50) of the detection electrode 122 when the pressing operation is performed with the predetermined pressing force by the electrostatic capacitance value (28) of the detection electrode 121 when the pressing operation is performed with the predetermined pressing force, for example.

In addition, the correction value multiplied to the electrostatic capacitance value of the detection electrode 122 when the correction unit 132 corrects the electrostatic capacitance value of the detection electrode 122 is 1, for example.

The case where the correction value multiplied to the electrostatic capacitance value of the detection electrode 122 is 1 can be regarded as a case where the correction unit 132 does not correct the electrostatic capacitance value of the detection electrode 122. However, the correction unit 132 correcting only the electrostatic capacitance value of the detection electrode 121 without correcting the electrostatic capacitance value of the detection electrode 122 is based on the electrostatic capacitance value of the detection electrode 122, and thus, is equivalent to setting the correction value multiplied to the electrostatic capacitance value of the detection electrode 122 to 1 and correcting the electrostatic capacitance values of the detection electrodes 121 and 122.

The correction unit 132 corrects the electrostatic capacitance values of the plurality of detection electrodes 121 and 122 using smaller correction values in cases where the displacement caused by the pressing operation performed at pressing positions overlapping the plurality of detection electrodes 121 and 122 on the operating surface 110A in the plan view becomes larger.

The plurality of correction values used when the correction unit 132 corrects the electrostatic capacitance values of the plurality of detection electrodes 121 and 122 have values such that the electrostatic capacitance values of the corresponding detection electrodes after the correction become identical in the case where the pressing operation is performed with the predetermined pressing force.

In a case where it is possible to reduce the threshold value TH, the correction unit 132 may correct the electrostatic capacitance value of the detection electrode 122 so that the electrostatic capacitance value of the detection electrode 122 when the pressing operation is performed with the predetermined pressing force becomes identical to the electrostatic capacitance value of the detection electrode 121 when the pressing operation is performed with the predetermined pressing force.

Further, the correction unit 132 may perform the correction by multiplying a correction value greater than 1 to the electrostatic capacitance values of the detection electrodes 121 and 122, so that the electrostatic capacitance values of the detection electrodes 121 and 122 become identical when the pressing operation is performed with the predetermined pressing force. In this case, an appropriate threshold value TH may be provided with respect to the electrostatic capacitance values of the detection electrodes 121 and 122 after the correction.

### <Electrostatic Capacitance Values Corrected by Correction Unit 132>

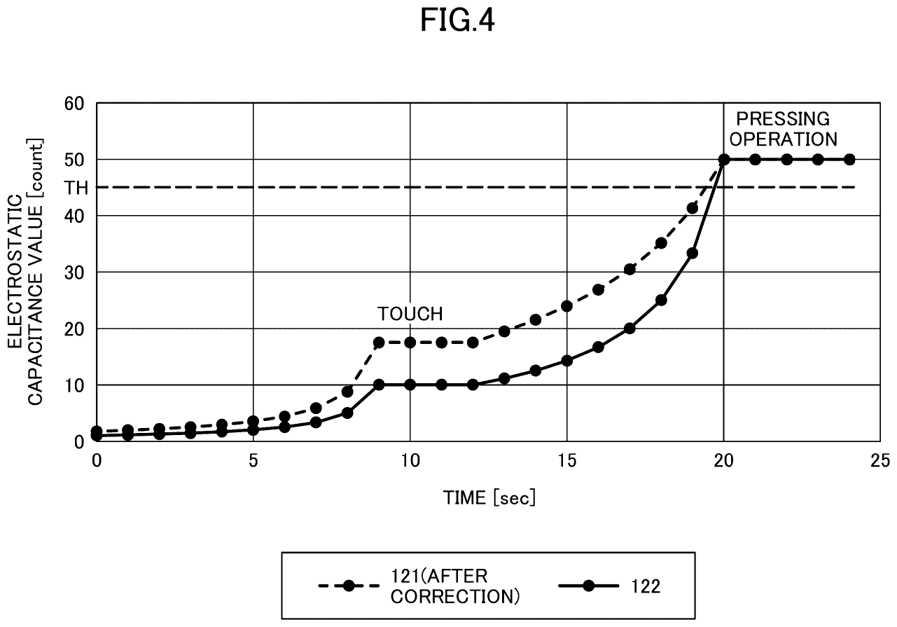

FIG. 4 is a diagram illustrating an example of the electrostatic capacitance values corrected by the correction unit 132 of the input device 100 according to the embodiment. FIG. 4 illustrates the electrostatic capacitance values (broken line) of the detection electrodes 121 corrected by the correction unit 132 when the pressing operation is performed on the hard foam layer 111 with the predetermined pressing force as illustrated in FIG. 2A, and the electrostatic capacitance values (solid line) of the detection electrodes 122 when the pressing operation is performed on the soft foam layer 112 with the predetermined pressing force as illustrated in FIG. 2B.

The abscissa and the ordinate in FIG. 4 represent the time (seconds) and the electrostatic capacitance value (electrostatic capacitance count value), respectively, similar to FIG. 3. The threshold value TH is the same as the threshold value TH illustrated in FIG. 3, and is 45 in the following description. The characteristics of the electrostatic capacitance value illustrated in FIG. 4 were obtained by performing the same operation as in the case of obtaining the characteristics of the electrostatic capacitance value illustrated in FIG. 3.

The characteristics of the electrostatic capacitance value of the detection electrode 122 indicated by the solid line are the same as the characteristics of the electrostatic capacitance value of the detection electrode 122 illustrated in FIG. 3. Accordingly, when the pressing operation is performed on the soft foam layer 112 with the predetermined pressing force, the electrostatic capacitance value of the detection electrode 122 becomes greater than or equal to the threshold value TH at the time of 20 seconds, and becomes a constant value of 50 on or after 20 seconds. On or after 20 seconds, the predetermined pressing force and the reaction force of the foam layer 112 become balanced, and the foam layer 112 assumes a state where the foam layer 112 cannot be pressed further downward.

In addition, the characteristics of the electrostatic capacitance value of the detection electrode 121 after the correction indicated by the broken line are characteristics obtained by multiplying a correction value (50/28 as an example) to the electrostatic capacitance value indicated by the broken line in FIG. 3. The electrostatic capacitance value of the characteristics indicated by the broken line in FIG. 4 becomes greater than or equal to the threshold value TH at the time of 20 seconds, and becomes a constant value of approximately 50 on or after 20 seconds. On or after 20 seconds, the predetermined pressing force and the reaction force of the foam layer 111 become balanced, and the foam layer 111 assumes a state where the foam layer 111 cannot be pressed further downward.

Accordingly, in the case where the hardnesses of the foam layers 111 and 112 differ, the correction unit 132 corrects the electrostatic capacitance values of the detection electrode 121 so that the difference in the distances L1 and L2 is canceled, and the change in the electrostatic capacitance value can be aligned when the pressing operation is performed on the foam layers 111 and 112 with the same predetermined pressing force. In other words, the correction value is set in advance so that the electrostatic capacitance values of the corresponding detection electrodes become identical in the case where the pressing operation with the predetermined pressing force is performed on the foam layers 111 and 112, and the correction unit 132 corrects the electrostatic capacitance values of the plurality of detection electrodes 121 and 122 measured by the measurement unit 131 using the correction value. As a result, it is possible to determine that the pressing operation is performed using the common threshold value TH (fixed criteria). That is, the determination unit 133 has the predetermined threshold value set in advance so as to determine that the pressing operation is performed even in a case where the pressing operation is performed with the predetermined pressing force at any of the pressing positions on the operating surface 110A. In other words, the control device 130 (determination unit 133) determines that the pressing operation is performed in a case where the pressing force exceeds a predetermined value for both of the foam layers 111 and 112 having the different hardnesses. To do this, the threshold value TH of the electrostatic capacitance value in the control device 130 (determination unit 133) needs to be set to an appropriate value in advance. The user can perform the pressing operation with the same tactile sensation with respect to both of the foam layers 111 and 112 having the different hardnesses, and the user can perform the pressing operation with the predetermined pressing force without perceiving unnatural tactile sensation due to the difference between the hardnesses of the foam layers 111 and 112.

### Modification of Embodiment

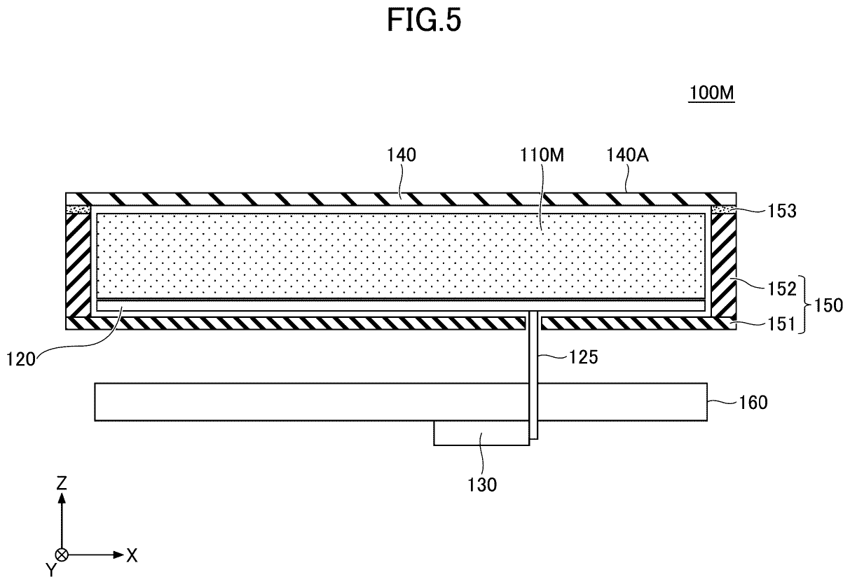

FIG. 5 is a diagram illustrating an example of a cross sectional configuration of an input device 100M according to a modification of the embodiment. The input device 100M includes a foam layer 110M, the electrostatic sensor 120, the control device 130, a skin 140, a base 150, and a substrate 160. The foam layer 110M and the skin 140 are examples of the input section, and an upper surface of the skin 140 constitutes an operating surface 140A.

The input device 100M can be attached to a part having cushioning properties, such as a door panel, an armrest, or the like of a vehicle, for example, but the input device 100M may be attached to other parts of the vehicle. The input device 100M may be installed on platforms other than the vehicle, such as a train, an aircraft, or the like. The platform on which the input device 100M is installed is not limited to a mobile platform, such as the vehicle, the train, the aircraft, or the like, and the input device 100M may be attached to an interior of a building or the like. Hereinafter, a case where the input device 100M is installed on the vehicle will be described as an example.

Because the configurations of the electrostatic sensor 120 and the control device 130 are the same as those of the electrostatic sensor 120 and the control device 130 of the input device 100 illustrated in FIG. 1, the foam layer 110M, the skin 140, the base 150, and the substrate 160 will be described in the following. The pressing operation is performed on the upper surface of the skin 140 constituting the operating surface 140A of the input device 100M.

### <Foam Layer 110M>

The foam layer 110M is disposed on the electrostatic sensor 120 that is provided on a flat portion 151 of the base 150, and is provided between the two wall portions 152. A thickness of the foam layer 110M in the Z-direction is aligned to a height of the wall portions 152 in the Z-direction, for example. The foam layer 110M can be made of a foam material, such as foam urethane, foam sponge, foam rubber, or the like, and has cushioning properties. An upper surface of the foam layer 110M is covered with the skin 140.

The foam layer 110M differs from the foam layer 110 (foam layers 111 and 112) illustrated in FIG. 1 in that the hardness of the portions of the foam layer 110M provided on all of the plurality of detection electrodes 121 and 122 of the electrostatic sensor 120 is constant.

### <Skin 140>

The skin 140 is a cover having elasticity and made of a resin, synthetic fiber, synthetic leather, leather, or the like, and the skin covers the entire upper surface of the foam layer 110M. The skin 140 has a rectangular shape in the plan view, for example, and ends along four sides of the skin 140 are bonded to upper ends of the wall portions 152 of the base 150 using an adhesive 153. A double-sided tape may be used in place of the adhesive 153, and the ends of the skin 140 and the upper ends of the wall portions 152 may be fixed by physically engaging the ends of the skin 140 and the upper ends of the wall portions 152.

### <Base 150>

The base 150 is a portion serving as the base of the input device 100M, and includes the flat portion 151 and the wall portions 152. The base 150 can be made of an insulator, such as a resin or the like, for example.

The flat portion 151 is a plate-shaped portion that holds the electrostatic sensor 120 and the foam layer 110M. The flat portion 151 has a rectangular shape in the plan view, for example, but is not limited to the rectangular shape and may have various shapes.

The wall portions 152 extend in the +Z-direction from ends of the flat portion 151 on the −X-direction side and the +X-direction side. The wall portions 152 are formed integrally with the flat portion 151, for example, but may be manufactured separately from the flat portion 151 and fixed to the flat portion 151. The wall portions 152 define a position in the X-direction where the foam layer 110M is disposed on the flat portion 151. The wall portions 152 are thin plate-like members parallel to a YZ-plane and extend in the Y-direction.

As an example, a case where one wall portion 152 is provided at each of the ends of the flat portion 151 on the −X-direction side and the +X-direction side will be described. However, the wall portions 152 may be provided at the ends of the flat portion 151 on the −Y-direction side and the +Y-direction side. The wall portions 152 may be provided at the ends on the −X-direction side and the +X-direction side and the ends on the −Y-direction side and the +Y-direction side. In this case, four wall portions 152 are provided along four sides of the flat portion 151 having a rectangular shape in the plan view.

The electrostatic sensor 120 is provided on the flat portion 151 of the base 150, and the foam layer 110M is provided on the electrostatic sensor 120.

### <Substrate 160>

A wiring board, such as a printed wiring board (PWB), a flexible printed circuit (FPC), or the like can be used for the substrate 160, for example. As an example, the control device 130 is provided on a lower surface of the substrate 160. Although a space is provided between the flat portion 151 of the base 150 and the substrate 160 in FIG. 5, the flat portion 151 may be disposed on and in contact with the substrate 160. In addition, the interconnect 125 may connect the electrostatic sensor 120 and the control device 130 via a route bypassing the ends of the substrate 160, or may pass through holes provided in the substrate 160. The interconnect 125 may connect the electrostatic sensor 120 and terminals or the like on an upper surface of the substrate 160, and the control device 130 may be connected to the interconnect 125 via an interconnect or the like of the substrate 160.

The input device 100M may display a symbol on a front face of the skin 140 by illuminating the skin 140 from under the skin with a light emitting diode (LED) or the like provided on the upper surface of the substrate 160 or the like. A portion having a shape of the symbol and capable of transmitting light may be provided in the skin 140, and a light emitting portion having the shape of the symbol can be provided by illuminating the lower surface of the skin 140 with the LED.

The symbol is a letter, a number, an icon, a line drawing, a graphical mark, or the like, for example, and represents a function, a type, or the like of an electronic device mounted on the vehicle, for example. Specific examples of the electronic device include switches of a power window or door mirror, control switches of an air conditioner, or the like, for example.

Accordingly, in a case where the LED is disposed on the upper surface of the substrate 160 to provide the light emitting portion having the shape of the symbol, portions of the base 150, the foam layer 110M, and the electrostatic sensor 120 positioned in an optical path may be made transparent, or a space may be provided in portions of the base 150, the foam layer 110M, and the electrostatic sensor 120 for allowing the light to pass.

### <Pressing Operation>

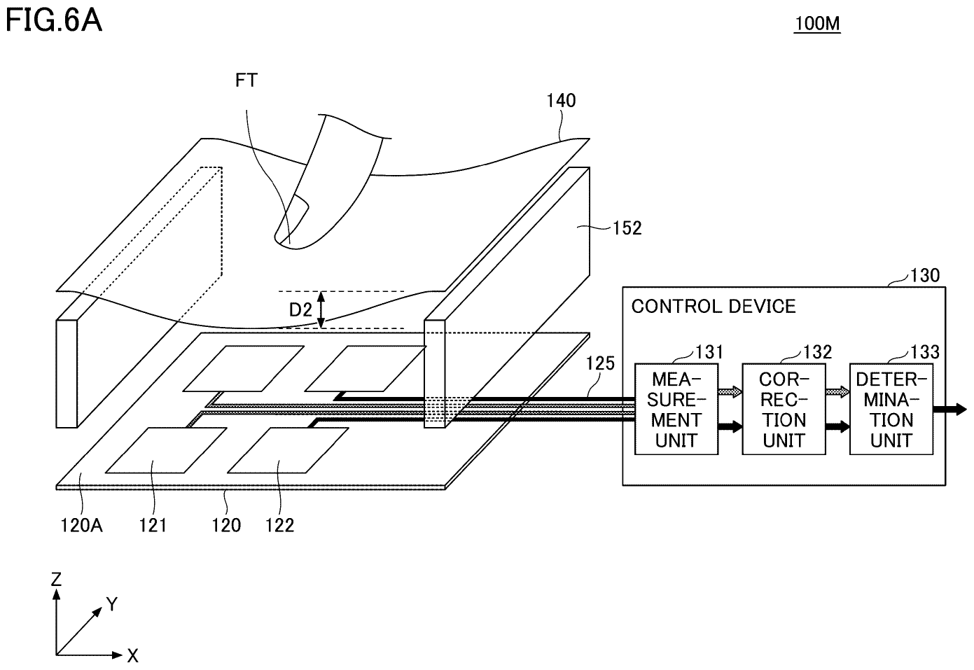

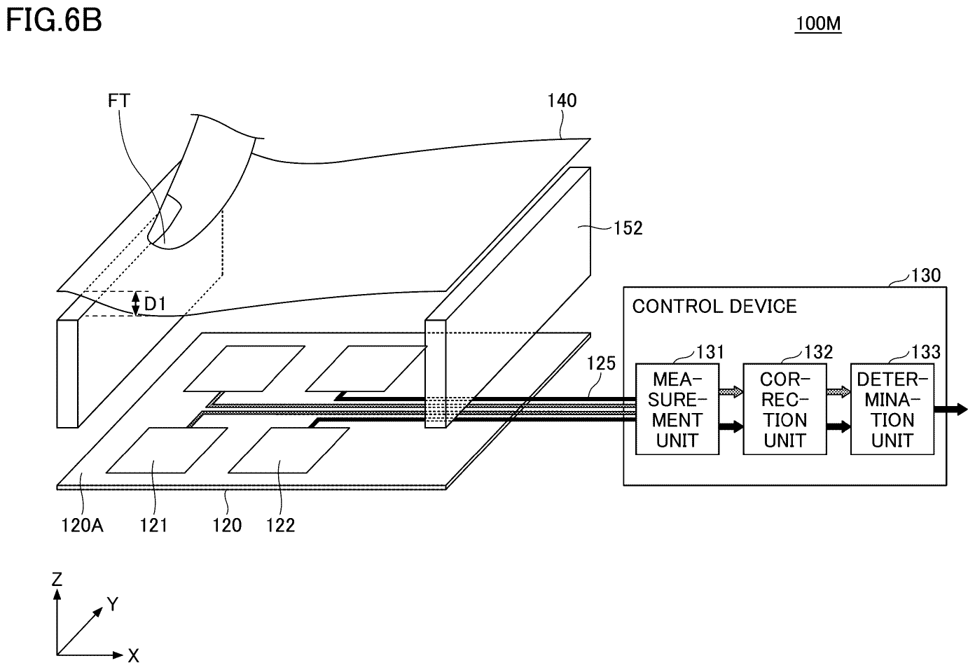

FIG. 6A and FIG. 6B are diagrams illustrating examples of states where the pressing operation is performed on the input device 100M with the fingertip FT. FIG. 6A and FIG. 6B illustrate the detection electrodes 121 and 122 of the electrostatic sensor 120 in the input device 100M. In addition, in FIG. 6A and FIG. 6B, the illustration of the foam layer 110M, the flat portion 151 of the base 150, and the substrate 160 is omitted.

The detection electrode 121 are provided on the −X-direction side of a center between the two wall portions 152 in the X-direction. The two detection electrodes 121 are arranged in the Y-direction along the wall portion 152 on the −X-direction side. The positions of the two detection electrodes 121 in the X-direction are identical.

The detection electrodes 122 are provided at positions equidistant from the two wall portions 152 in the X-direction. The two detection electrodes 122 are arranged in the Y-direction, and the positions of the two detection electrodes 122 in the X-direction are identical.

The detection electrodes 121 may also be disposed on the +X-direction side symmetrically to the detection electrodes 121 on the −X-direction side with respect to the detection electrodes 122, but a description of such an arrangement will be omitted.

FIG. 6A illustrates a state where the pressing operation is performed at a position directly above the detection electrode 122 at a central portion of the skin 140 in the X-direction. FIG. 6B illustrates a state where the pressing operation is performed at a position directly above the detection electrode 121 at an end portion of the skin 140 on the −X-direction side in the X-direction.

As illustrated in FIG. 6A, the central portion of the skin 140 in the X-direction is separated from the wall portions 152, and thus, the skin 140 is easily deformable into a concave shape. For this reason, when the pressing operation is performed at the central portion of the skin 140 in the plan view with the predetermined pressing force, the skin 140 is easily pressed downward because the central portion of the skin 140 is resilient. In this case, the displacement of the skin 140 in the Z-direction is D2.

Further, as illustrated in FIG. 6B, the end portion of the skin 140 on the −X-direction side is near the portion where the skin 140 is bonded to the wall portion 152, and thus, the skin 140 is less likely to be deformed than the central portion of the skin 140 in the plan view. For this reason, when the end portion of the skin 140 on the −X-direction side is pressed with the predetermined pressing force, the skin 140 is not easily pressed downward because the end portion of the skin 140 is not as resilient as the central portion. In this case, the displacement of the skin 140 in the Z-direction is D1, and the displacement D1 is smaller than the displacement D2.

As described above, the displacements D2 and D1 are different between the case where the pressing operation is performed at the central portion of the skin 140 in the X-direction and the case where the pressing operation is performed at the end portion of the skin 140 on the −X-direction side, and thus, the distances between the fingertip FT and the detection electrodes 121 and 122 are also different.

When the correction unit 132 corrects the electrostatic capacitance value of the detection electrode 121 so as to cancel the difference in the distances between the fingertip FT and the detection electrodes 121 and 122 due to the difference in the displacements D1 and D2, the electrostatic capacitance values of the detection electrodes 121 and 122 when the pressing operation is performed with the predetermined pressing force can be aligned. In other words, the correction unit 132 has a correction value that is set in advance so that the electrostatic capacitance values of the corresponding detection electrodes become identical regardless of whether the pressing operation with the predetermined pressing force is performed at the central portion or the end portion of the skin 140. As a result, the determination unit 133 can determine that the pressing operation is performed with the predetermined pressing force, using the common threshold value TH. That is, the determination unit 133 has a predetermined threshold value that is set in advance so as to determine that the pressing operation is performed even in a case where the pressing operation is performed with the predetermined pressing force at any pressing position on the operating surface 140A. In other words, the control device 130 determines that the pressing operation is performed in a case where the pressing force exceeds a predetermined value for both the central portion and the end portion of the skin 140. To do this, the threshold value TH for the electrostatic capacitance value in the control device 130 (determination unit 133) needs to be set to an appropriate value in advance. Further, the user can perform the pressing operation with the same tactile sensation regardless of whether the pressing operation is performed at the central portion of the skin 140 in the X-direction or at the end portion of the skin 140 on the −X-direction side, and the user can perform the pressing operation with the predetermined pressing force without perceiving unnatural tactile sensation due to the difference in hardness at the central portion and the end portion of the skin 140.

The input device 100M according to the modification of the embodiment is described above with reference to FIG. 5, FIG. 6A, and FIG. 6B. The input device 100M includes the foam layer 110M. However, the input device 100M may not include the foam layer 110M. Even when the input device 100M does not include the foam layer 110M, if the end portion of the skin 140 is fixed to the wall portion 152, the displacement is different between the case where the pressing operation is performed at the central portion of the skin 140 in the X-direction and the case where the pressing operation is performed at the end portion of the skin 140 on the −X-direction side. For this reason, even in the case where the input device 100M does not include the foam layer 110M, the correction unit 132 can correct the electrostatic capacitance value of the detection electrode 121, and thus, the electrostatic capacitance values of the detection electrodes 121 and 122 when the pressing operation is performed with the predetermined pressing force can be aligned. Further, the user can perform the pressing operation with the same tactile sensation regardless of whether the pressing operation is performed at the central portion of the skin 140 in the X-direction or at the end portion of the skin 140 on the −X-direction side, and the user can perform the pressing operation with the predetermined pressing force without perceiving unnatural tactile sensation due to the difference in hardness at the central portion and the end portion of the skin 140.

### <Effects>

The input device 100 includes the input section (foam layer 110) having the operating surface (110A, 140A) configured to be operated by the manipulating body (fingertip FT), the plurality of detection electrodes 121 and 122 provided on a back side of the operating surface, the measuring unit 131 configured to measure the electrostatic capacitance value of each detection electrode of the plurality of detection electrodes 121 and 122, and the correction unit 132 configured to correct the electrostatic capacitance value of each detection electrode of the plurality of detection electrodes 121 and 122 measured by the measurement unit 131. The input section (foam layer 110) has portions where the displacement with respect to the pressing operation with the predetermined pressing force on the operating surface by the manipulating body is different depending on positions on the operating surface. The correction unit 132 corrects the electrostatic capacitance value of each detection electrode of the plurality of detection electrodes 121 and 122 using smaller correction values for cases where a displacement caused by the pressing operation performed at pressing positions overlapping the plurality of detection electrodes 121 and 122 on the operating surface in the plan view becomes larger. For this reason, even when the pressing operation is performed at a portion where the displacement with respect to the pressing operation with the predetermined pressing force varies depending on the position on the operating surface, the electrostatic capacitance values of the plurality of detection electrodes 121 and 122 can be aligned.

Accordingly, it is possible to provide the input device 100 capable of determining that the pressing operation is performed on the operating surface based on fixed criteria.

The input device may further include the determination unit 133 configured to determine that the pressing operation is performed on the operating surface by the manipulating body in the case where the electrostatic capacitance value corrected by the correction unit 132 is greater than or equal to a predetermined threshold value (threshold value TH). In the case where the electrostatic capacitance value corrected by the correction unit 132 is greater than or equal to the predetermined threshold value (threshold value TH), the determination unit 133 determines that the pressing operation is performed, and thus, it is possible to provide the input device 100 capable of determining that the pressing operation is performed on the operating surface based on fixed criteria.

The determination unit 133 may have a predetermined threshold value (TH) set in advance so as to determine that the pressing operation is performed even in the case where the pressing operation is performed with the predetermined pressing force at any pressing position on the operating surface 110A. Even in the case where the pressing operation is performed with the predetermined pressing force at any pressing position, it is possible to provide the input device 100 capable of reliably determining that the pressing operation is performed and determining that the pressing operation is performed using the common threshold value TH.

The plurality of correction values used when the correction unit 132 corrects the electrostatic capacitance values of the plurality of detection electrodes 121 and 122 may have values such that the electrostatic capacitance values of the corresponding detection electrodes after the correction become identical in the case where the pressing operation is performed with the predetermined pressing force. Even in the case where the pressing operation is performed with the predetermined pressing force at any pressing position on the operating surface, the electrostatic capacitance values of the plurality of detection electrodes 121 and 122 become identical, and thus, it is possible to provide the input device 100 capable of determining that the pressing operation is performed using the common threshold value TH.

The input section may further include the base 150 that holds the input section, the base 150 may include the wall portions 152 adjacent to the end portion of the input section in the plan view, the input section may include the foam layer 110 and the skin 140 that covers the foam layer 110, and the end portion of the skin 140 may be fixed to the end of the wall portion 152 adjacent to the end of the input section. By fixing the end portion of the skin 140 to the wall portion 152, it is possible to provide the input device 100 capable of determining that the pressing operation is performed on the operating surface based on fixed criteria even in the case where the displacement of the skin 140 is different between the central portion and the end portion of the skin 140.

According to the present disclosure, it is possible to provide an input device capable of determining presence of a pressing operation with respect to a sensor operating surface based on fixed criteria.

Although the input device according to the embodiments of the present disclosure is described heretofore, the present disclosure is not limited to the specifically disclosed embodiments, and various variations and modifications may be made without departing from the scope of the subject matter recited in the claims.

What is claimed is:

1. An input device comprising:
an input section having an operating surface configured to be operated by a manipulating body;
a plurality of detection electrodes provided on a back side of the operating surface;
a measurement circuit configured to measure an electrostatic capacitance value of each detection electrode of the plurality of detection electrodes; and
a correction circuit configured to correct the electrostatic capacitance value of each detection electrode of the plurality of detection electrodes measured by the measurement circuit, wherein:
the input section is configured to include portions where displacements with respect to a pressing operation on the operating surface by the manipulating body with a predetermined pressing force differ depending on positions on the operating surface, and
the correction circuit is configured to correct the electrostatic capacitance value of each detection electrode of the plurality of detection electrodes using smaller correction values for cases where a displacement caused by the pressing operation performed at pressing positions overlapping the plurality of detection electrodes on the operating surface in a plan view becomes larger.

2. The input device as claimed in claim 1, further comprising:
a determination circuit configured to determine that the pressing operation is performed on the operating surface by the manipulating body in a case where the electrostatic capacitance value corrected by the correction circuit is greater than or equal to a predetermined threshold value.

3. The input device as claimed in claim 2, wherein the determination circuit has the predetermined threshold value set in advance so as to determine that the pressing operation is performed even in a case where the pressing operation is performed with the predetermined pressing force on any of the pressing positions on the operating surface.

4. The input device as claimed in claim 1, wherein a plurality of correction values used when the correction circuit corrects the electrostatic capacitance values of the plurality of detection electrodes have values such that electrostatic capacitance values of corresponding detection electrodes after correction become identical in the case where the pressing operation is performed with the predetermined pressing force.

5. The input device as claimed in claim 1, further comprising:
a base configured to hold the input section, wherein:
the base includes a wall portion adjacent to an end portion of the input section in the plan view,
the input section includes:
a foam layer, and
a skin covering the foam layer, and
an end portion of the skin is fixed to an end of the wall portion adjacent to the end portion of the input section.
